(19) United States
(12) Patent Application Publication
(10) Pub. No.: US 2023/0349321 A1
(43) Pub. Date: Nov. 2, 2023

(54) BOTTOMING CYCLE WITH ISOLATED TURBO-GENERATORS

(71) Applicant: RAYTHEON TECHNOLOGIES CORPORATION, Farmington, CT (US)

(72) Inventors: Stephen H. Taylor, East Hartford, CT (US); Malcolm P. MacDonald, Bloomfield, CT (US); Dmytro M. Voytovych, Rocky Hill, CT (US); Brian M. Holley, Eastford, CT (US)

(21) Appl. No.: 17/730,849

(22) Filed: Apr. 27, 2022

(51) Int. Cl. F02C 3/10; F02C 6/18; F01D 15/10

(52) U.S. Cl. CPC F02C 3/10; F02C 6/18; F01D 15/10; F05D 2260/213; F05D 2210/12; F05D 2220/323; F05D 2260/10

(57) ABSTRACT

A propulsion system for an aircraft includes a core engine that includes a core flow path that is in communication with a compressor section, combustor section and a turbine section, the core engine is configured to generate a high energy gas flow, a first cycle turbine that is configured to drive a first cycle compressor at a cycle speed in response to expansion of a heated working fluid flow between a first inlet and a first outlet of the first cycle turbine, and a first power turbine that is configured to drive a first output shaft at a power speed that is different than the cycle speed in response to expansion of a working fluid flow received from the first outlet of the first cycle turbine.

### STATEMENT REGARDING FEDERALLY SPONSORED RESEARCH OR DEVELOPMENT

This subject of this disclosure was made with government support under Contract No.: DE-AR0001342 awarded by the United States Department of Energy. The government therefore may have certain rights in the disclosed subject matter.

### TECHNICAL FIELD

The present disclosure relates generally to a system for recovering waste heat in a gas turbine engine, and more specifically to a work recovery system utilizing a supercritical CO2 cycle to recover work from excess heat.

### BACKGROUND

Improving engine operating efficiencies are driven by economic and environmental demands. A gas turbine engine typically mixes a carbon based fuel with air within a combustor where it is ignited to generate a high-energy exhaust gas flow. The largest inefficiency of a gas turbine engine is usually the loss of high-quality thermal energy in the exhaust gas flow vented to atmosphere, known as waste heat. Capture and power conversion of waste heat has the potential to significantly increase overall engine operating efficiency.

Turbine engine manufacturers continue to seek further improvements to engine performance including improvements to thermal, transfer and propulsive efficiencies.

### SUMMARY

A propulsion system for an aircraft according to an exemplary embodiment of this disclosure, among other possible things includes a core engine that includes a core flow path that is in communication with a compressor section, combustor section and a turbine section, the core engine is configured to generate a high energy gas flow, a first cycle turbine that is configured to drive a first cycle compressor at a cycle speed in response to expansion of a heated working fluid flow between a first inlet and a first outlet of the first cycle turbine, and a first power turbine that is configured to drive a first output shaft at a power speed that is different than the cycle speed in response to expansion of a working fluid flow received from the first outlet of the first cycle turbine.

In a further embodiment of the foregoing, the propulsion system includes a first power conversion device that is coupled to the first power turbine.

In a further embodiment of any of the foregoing, the propulsion system includes a second power turbine and a second power conversion device. The second power turbine is configured to drive the second power conversion device through a second output shaft. The second power turbine receives an exhausted working fluid flow.

In a further embodiment of any of the foregoing, the power conversion device is one of a power consuming electric machine or mechanical machine.

In a further embodiment of any of the foregoing, the propulsion system includes a second cycle turbine that is configured to drive a second cycle compressor that is responsive to an expanding working fluid flow. The second cycle turbine includes a second inlet that is in communication with a working fluid flow that is exhausted from one of the first power turbine or the first cycle turbine.

In a further embodiment of any of the foregoing, the propulsion system includes a third cycle turbine that is configured to drive a third cycle compressor that is responsive to an expanding working fluid flow. The third cycle turbine includes a third inlet that is in communication with a working fluid flow that is exhausted from one of the second power turbine or the second cycle turbine.

In a further embodiment of any of the foregoing, each of the first cycle turbine, the second cycle turbine and the third cycle turbine are configured to drive a corresponding one of the first cycle compressor, the second cycle compressor and the third cycle compressor.

In a further embodiment of any of the foregoing, the second power turbine is configured to rotate at a speed that corresponds with the second power conversion device.

In a further embodiment of any of the foregoing, the power speed of the power turbine is lower than the cycle speed of the cycle turbine.

In a further embodiment of any of the foregoing, the working fluid flow comprises CO2.

In a further embodiment of any of the foregoing, the propulsion system includes at least one heat exchanger that is configured to communicate thermal energy from the high energy gas flow into the working fluid flow.

In a further embodiment of any of the foregoing, the first power turbine is coupled to a shaft of the core engine through the first output shaft.

In a further embodiment of any of the foregoing, the propulsion system includes a coupling device that is configured to transfer power from the first output shaft into the shaft of the core engine.

A bottoming cycle system for recovering energy from a heat source, the bottoming cycle system according to an exemplary embodiment of this disclosure, among other possible things includes a plurality of cycle turbines that are configured to drive a corresponding plurality of cycle compressors at a cycle speed in response to expansion of a heated working fluid flow between a first inlet and a first outlet of each of the plurality of cycle turbines, and a first power turbine that is configured to drive a first output shaft at a power speed that is different than the cycle speed in response to expansion of a working fluid flow that is received from one of the plurality of cycle turbines.

In a further embodiment of the foregoing, the bottoming cycle system includes a first power conversion device that is coupled to the output shaft and configured to generate power in response to rotation of the first output shaft.

In a further embodiment of any of the foregoing, the power conversion device includes one of an electric machine, pump, gearbox or mechanical machine.

In a further embodiment of any of the foregoing, the plurality of cycle turbines includes three cycle turbines that are arranged in flow series communication such that working fluid flow is exhausted from a first cycle turbine and is communicated to a second cycle turbine and then communicated to a third cycle turbine.

In a further embodiment of any of the foregoing, the bottoming cycle system includes a second power turbine in flow series communication with the first power turbine and flow exhausted from third cycle turbine is communicated to the first power turbine and flow exhausted from the first power turbine is communicated to the second power turbine.

In a further embodiment of any of the foregoing, the bottoming cycle system includes a second power turbine that is configured to drive a second output shaft at the power speed and a second power generation device is configured to generate power in response to rotation of the second output shaft.

In a further embodiment of any of the foregoing, the plurality of cycle turbines includes three cycle turbines that are arranged in flow series with the first power turbine and the second power turbine such that working fluid flow exhausted from a first cycle turbine is communicated to the first power turbine, flow exhausted from the first power turbine is communicated to the second cycle turbine, flow exhausted from the second cycle turbine is communicated to the second power turbine and flow exhausted from the second power turbine is communicated to the third cycle turbine.

In a further embodiment of any of the foregoing, the plurality of cycle compressors are arranged in a serial flow configuration such that flow from one of the plurality of cycle compressors is communicated to a next one of the plurality of compressors.

In a further embodiment of any of the foregoing, the plurality of cycle compressors are in communication with at least one recuperator for transferring thermal energy from a higher temperature, lower pressure point of the working fluid flow into a lower temperature, higher pressure point of the working flow.

In a further embodiment of any of the foregoing, the first output shaft is coupled to a shaft of a turbine engine.

In a further embodiment of any of the foregoing, the bottoming cycle system includes a coupling device that is configured to transmit power from the first output shaft into the shaft of the turbine engine.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 schematically shows an example propulsion system embodiment.

FIG. 2 schematically shows an example bottoming cycle system embodiment.

FIG. 3 schematically shows another example bottoming cycle system embodiment.

FIG. 4 schematically shows another example bottoming cycle system embodiment.

### DETAILED DESCRIPTION

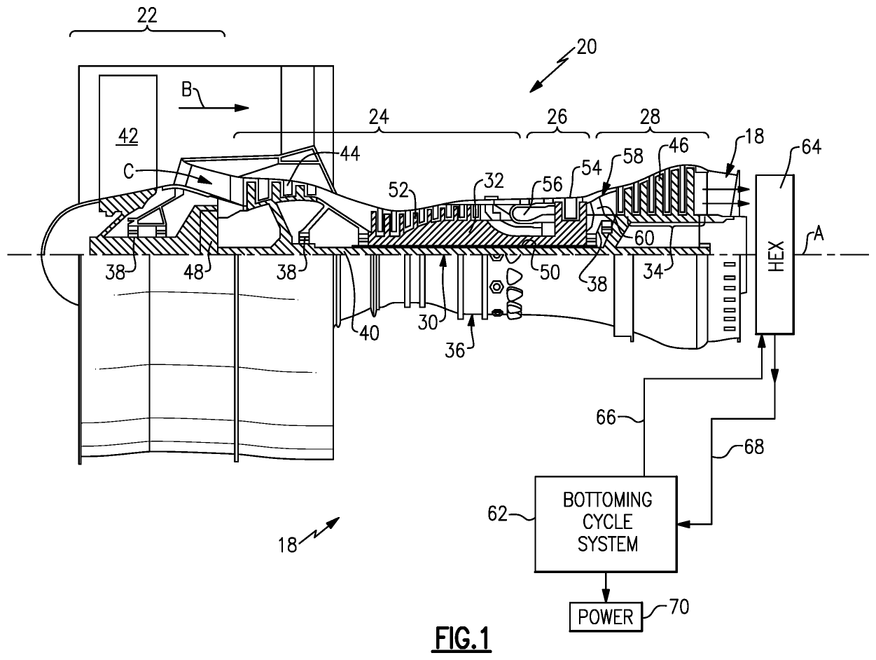

FIG. 1 schematically illustrates an example propulsion system 18 that includes at least one gas turbine engine 20 and a first bottoming cycle 62 controlled to efficiently adapt waste heat power generation to operating conditions.

The example gas turbine engine 20 includes an optional fan section 22, a compressor section 24, a combustor section 26 and a turbine section 28. In embodiments where the engine does not directly drive a fan, the power produced may be used to drive any mechanical or electrical system of interest. If present, the fan section 22 drives air along a bypass flow path B. The compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive either the fan section 22, other power consuming systems, and the compressor section 24.

Although the disclosed non-limiting embodiment depicts a two-spool turbofan gas turbine engine, it should be understood that the concepts described herein are not limited to use with two-spool turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section. Moreover, the features and embodiments presented are applicable to land based turbine engines.

Additionally, the example turbine engine 20 is described as utilizing a carbon based fuel, however, other fuels may be utilized within the contemplation and scope of this disclosure. For example, a hydrogen based fuel could be utilized and is within the contemplation and scope of this disclosure.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that provides shaft power to drive the fan section 22 or a power system generating system. In one disclosed example, the inner shaft 40 connects a low pressure (or first) compressor section 44 to a low pressure (or first) turbine section 46. The inner shaft 40 drives the fan section 22 through a speed change device, such as a geared architecture 48, to drive the fan 42 (or power system) at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

Airflow through the core airflow path C is compressed by the low pressure compressor 44, then by the high pressure compressor 52 mixed with fuel, then ignited in the combustor 56 to produce high speed exhaust gas. This gas is then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment, the low fan pressure ratio is less than about 1.45.

“Low corrected fan tip speed” is the actual fan tip speed in ft/sec divided by an industry standard temperature correction of [(Tram ° R)/(518.7° R)]⁰⁵. The “Low corrected fan tip speed”, as disclosed herein according to one non-limiting embodiment, is less than about 1150 ft/second.

For engine embodiments that include the fan section, the fan section 22 comprises in one non-limiting embodiment less than about 26 fan blades 42. In another non-limiting embodiment, the fan section 22 includes less than about 20 fan blades 42. Moreover, in one disclosed embodiment the low pressure turbine 46 includes no more than about 6 turbine rotors schematically indicated at 34. In another non-limiting example embodiment, the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

Thermal energy produced through the combustion process is wasted as the high energy exhaust gas flow is vented to atmosphere after expansion through the turbine section 28. The thermal energy vented to atmosphere can be used to drive other systems to produce electricity. The disclosed example propulsion system includes a bottoming cycle system 62 that utilizes a working fluid flow circulated through a heat exchanger 64 to accept thermal energy from the high energy exhaust gas flow 18. A cool working fluid flow 66 accepts thermal energy from the high energy exhaust gas flow 18 as a heated working fluid flow 68 that is utilized by the bottoming cycle system 62 to produce power schematically indicated at 70.

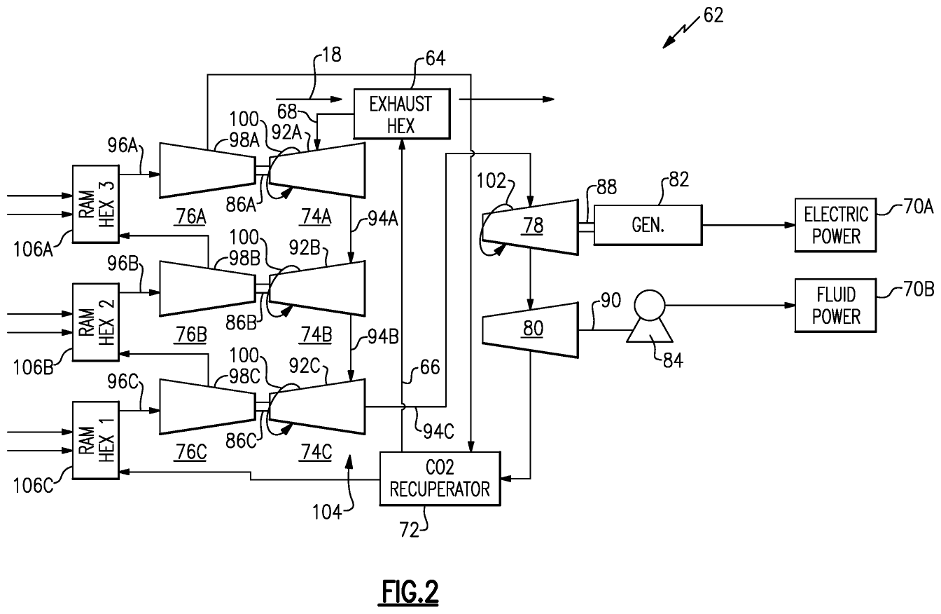

Referring to FIG. 2 with continued reference to FIG. 1, the example bottoming cycle system 62 includes cycle turbines 74A-C configured to drive cycle compressors 76A-C and differently configured power turbines 78, 80 that drive a power conversion device such as a generator 82 or pump 84. The differently configured cycle turbines 74A-C and power turbines 78, 80 tailor operation and speed to the driven device. It should be understood that the example cycle turbines 74A-C and power turbines 78, 80 are one configuration of a device that converts heat into useful shaft work. Moreover, the disclosed example turbines maybe a centrifugal or an axial flow device. Further, each compressor or turbine as discussed herein may be composed of a plurality of stages when reduced to practice.

The plurality of cycle turbines 74A-C are coupled to drive the corresponding plurality of cycle compressors 76A-C by way of a corresponding drive shaft 86A-C. The first power turbine 78 is configured to drive a generator 82 through a first output shaft 88. The second power turbine 80 is configured to drive a pump 84 through a second output shaft 90. The cycle turbines 74A-C drive the corresponding cycle compressors 76A-C at individually optimized speeds for a desired operation of the cycle compressors 76A-C. The power turbines 78, 80 operate at different, individually optimized speeds that are significantly different than the speeds of cycle compressors 76A-C and turbines-C.

The operating speeds of drive shafts 86A-C provide for desired operation of the cycle compressors 76A-C. The fluid at the inlet to compressors 76A-C is at the highest density state of all states in the cycle. In general, this necessitates that compressors 76A-C be designed as physically smaller machines than cycle turbines 74A-C or power turbines 78, 80. Further, the optimal operation speed of a compressor or turbine increases when size decreases. Further, compressor machines are in general less tolerant to operation at speeds different than the optimal speed than are turbine machines. Thus, the target optimal speed of shafts 86A-C is a balance between the individual optimal speeds of the compressor and turbine on each shaft. In one disclosed example, this speed can be between 50 and 100 kilo-revolutions per minute (krpm). This speed is much higher than desired for operation of the either the generator 82 or the pump 84.

Accordingly, the power turbines 78 and 80 are configured differently than the cycle turbines 74A-C to utilize the same working fluid flow rate to operate at speeds which are desired for operation of the generator 82, pump 84 to provide corresponding power outputs schematically shown at 70A-B. The example power turbines 78, 80 provide desired operation, including the second speed 102, for operation of the device providing for the output of power. The output of power, in this disclosed example, is provide by either the generator 82 or the pump 84.

The example working fluid flow comprises a carbon dioxide fluid flow maintained at or above the supercritical point and therefore is referred to in this disclosure as supercritical carbon dioxide (SCO₂). The working fluid flow is configured to remain above the supercritical point during transfer of thermal energy from exhaust heat exchanger 64 to the fluid and through expansion through the cycle turbines 74A-C.

The working fluid flow 66, being at high pressure, is heated from an initial temperature to high temperature within the exhaust heat exchanger 64 by the exhaust gas flow 18. The exhaust heat exchanger 64 is configured to transfer thermal energy from the high energy exhaust gas flow 18 into the working fluid flow.

Although the example heat exchanger 64 is located aft of the turbine section 28, the heat exchanger 64 may be located within other heat producing areas of the engine 20. Moreover, although the heat exchanger 64 is schematically shown as a single heat exchanger, multiple heat exchangers may also be utilized and are within the contemplation of this disclosure.

The hot working fluid flow 68 is communicated to an inlet 92A of the first cycle turbine 74A. The hot working fluid flow 68 expands between the first inlet 92A and the first outlet 94A to drive the first cycle turbine 74A and thereby the first cycle compressor 76A. In this disclosed example, the cycle turbines 74A-C are arranged in a flow series arrangement indicated at 104 such that the working fluid flow expands through each cycle turbine 74A-C between a corresponding inlet 92A-C and outlet 94A-C. Accordingly, the working fluid flow from the first cycle turbine 74A is communicated to the second inlet 92B of the second cycle turbine 74B. From the second cycle turbine 74B, working fluid flow is communicated to the third inlet 92C of the third cycle turbine 74C.

The working fluid flow from the last or third cycle turbine 74C is communicated to the power turbines 78, 80. In this disclosed example, the working fluid flow is first communicated and expanded through the first power turbine 78 to drive the generator 82. The working fluid flow exhausted from the first power turbine 78 is communicated to the second power turbine 80. The working fluid flow expands through the second power turbine 80 and is then communicated to the recuperator 72.

The example recuperator 72 is configured to place the hot, low pressure working fluid flow exhausted from the second power turbine 80, in thermal communication with the cooler working fluid flow exiting compressor 76A. Expansion through the cycle turbines 74A-C and the power turbines 78, 80 reduces pressure and temperature. However, in one disclosed example, useful thermal energy remains in the flow after exiting the sequence of turbines 74A-C, 78, 80. Thus, thermal energy not extracted as power by the sequence of turbines is recycled via thermal communication into the high pressure fluid flow exiting compressor 76A within recuperator 72. In this process, the low pressure flow exiting power turbine 80 is cooled within recuperator 72 before proceeding to ram heat exchanger 106C. In the cycle compressors 76A-C, the pressure of the working fluid flow is elevated and communicated back to recuperator 72 to accept thermal energy, then to exhaust heat exchanger 64 to accept further thermal energy.

In this example embodiment, the working fluid flow is communicated from each of the cycle compressors 76A-C through a corresponding ram air heat exchanger 106A-C. The ram air heat exchangers 106A-C provide for cooling of the pressurized working fluid flow as necessary to perpetually maintain the working fluid flow at desired pressures and temperatures. In the disclosed example shown in FIG. 2, the cycle compressors 76A-C are arranged in a flow series arrangement with the ram air heat exchangers 106A-C.

The flow series arrangement provides for working fluid exhausted through the recuperator 72 or a corresponding compressor outlet 98A-B to be communicated through one of the ram air heat exchangers 106A-C, then to an inlet 96A-C of the next cycle compressor 76A-C.

In one disclosed example, working fluid flow from the recuperator 72 is communicated through the ram air heat exchanger 106C, then to the third cycle compressor 76C. From the third cycle compressor 76C, the working fluid flow is communicated through corresponding ones of the ram air heat exchangers 106B-C and cycle compressors 76B-C. Finally, the output working fluid flow is communicated back through the recuperator 72 to be heated, then back to the exhaust heat exchanger 64 to be further heated.

It should be appreciated, that the flow series arrangement shown in FIG. 2 is disclosed and described as an example, and other flow routing and configurations are possible within the scope and contemplation of this disclosure. Moreover, although three cycle compressors 76A-C, cycle turbines 74A-C and ram air heat exchangers are shown and described by way of example, more or less of each may be utilized within the scope and contemplation of this disclosure.

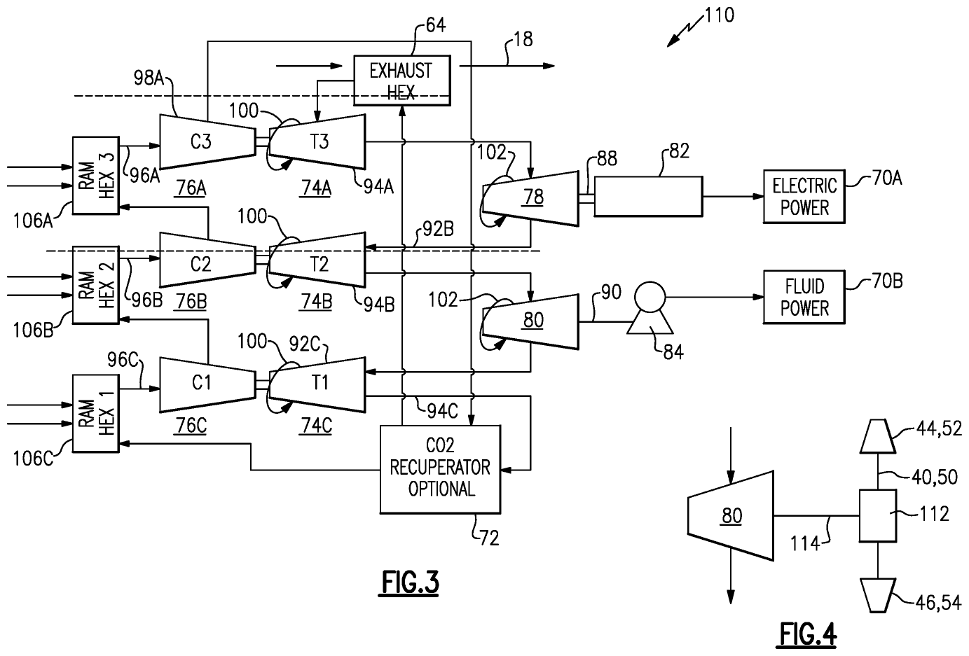

Referring to FIG. 3, another example bottoming system 110 is schematically illustrated and includes a different flow arrangement for the working fluid flow. In this disclosed example, working fluid flow exhausted from the first cycle turbine 74A is communicated to the first power turbine 78. From the first power turbine 78, the working fluid flow is communicated to the second cycle turbine 74B, then to the second power turbine 80. Each of the power turbines 78, 80 are in flow series communication between two of the cycle turbines 74A-C. The cycle compressors 76A-C are arranged in flow series communication as shown and described with regard to the bottoming system 62 shown in FIG. 2.

The example second power turbine 80 is disclosed and described as driving a pump 84. However, the second power turbine 80 may also drive a generator, or any other power conversion device. Moreover, the first power turbine 78 and the second power turbine 80 are illustrated schematically the same. However, each of the power turbines 78, 80 maybe differently configured to generate a desired output speed tailored to the specific power generation device. The power turbines 78, 80 may be configured as either an axial turbine or a radial turbine depending on application specific requirements.

The disclosed cycle turbines 74A-C are also disclosed schematically the same, but each may be differently configured depending on the requirements of the corresponding one of the cycle compressors 76A-C.

Each of the disclosed bottoming systems 62, 110 decouple speeds required for operation of the cycle compressors 76A-C from the speeds required to operate the generator 82, pump 84 or other power conversion device.

Referring to FIG. 4, in another disclosed example embodiment, the power turbine 80 may be coupled to input power into one of the core engine shafts 40, 50. In this example, the power turbine 80 drives a shaft 114 that is coupled to one of the inner shaft 40 that couples the LPT 46 to the LPC 44 or the outer shaft 50 that couples the HPT 54 to the HPC 52. The shaft 114 can be directly or selectively coupled through a coupling device 112. The coupling device 112, may be a gearbox, gear assembly, mechanical clutch, electro-mechanical clutch, hydraulic clutch or any other coupling for transmitting power from the power turbine 80. Moreover, although a single power turbine is schematically shown, separate power turbines may be coupled to each of the shafts 40, 50. It should be appreciated that different engine architectures are within the contemplation of this disclosure and may include a power turbine selectively coupled to any core engine shaft.

While described above in conjunction with a geared turbofan engine, it is appreciated that the waste heat recovery system described herein can be utilized in conjunction with any other type of turbine engine with only minor modifications that are achievable by one of skill in the art. Moreover, the disclosed example bottoming cycle systems may be utilized for recovering thermal energy from any heat source.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A propulsion system for an aircraft comprising;
a core engine including a core flow path in communication with a compressor section, combustor section and a turbine section, the core engine configured to generate a high energy gas flow;
a first cycle turbine configured to drive a first cycle compressor at a cycle speed in response to expansion of a heated working fluid flow between a first inlet and a first outlet of the first cycle turbine; and
a first power turbine configured to drive a first output shaft at a power speed that is different than the cycle speed in response to expansion of a working fluid flow received from the first outlet of the first cycle turbine.

2. The propulsion system as recited in claim 1, including a first power conversion device coupled to the first power turbine.

3. The propulsion system as recited in claim 2, including a second power turbine and a second power conversion device, the second power turbine configured to drive the second power conversion device through a second output shaft, the second power turbine receiving an exhausted working fluid flow.

4. The propulsion system as recited in claim 3, wherein the power conversion device is one of a power consuming electric machine or mechanical machine.

5. The propulsion system as recited in claim 3, including a second cycle turbine configured to drive a second cycle compressor responsive to an expanding working fluid flow, wherein the second cycle turbine includes a second inlet that is in communication with a working fluid flow exhausted from one of the first power turbine or the first cycle turbine.

6. The propulsion system as recited in claim 5, including a third cycle turbine configured to drive a third cycle compressor responsive to an expanding working fluid flow, wherein the third cycle turbine includes a third inlet that is in communication with a working fluid flow exhausted from one of the second power turbine or the second cycle turbine.

7. The propulsion system as recited in claim 6, wherein each of the first cycle turbine, the second cycle turbine and the third cycle turbine are configured to drive a corresponding one of the first cycle compressor, the second cycle compressor and the third cycle compressor.

8. The propulsion system as recited in claim 3, wherein the second power turbine is configured to rotate at a speed corresponding with the second power conversion device.

9. The propulsion system as recited in claim 1, wherein the power speed of the power turbine is lower than the cycle speed of the cycle turbine.

10. The propulsion system as recited in claim 1, wherein the working fluid flow comprises CO2.

11. The propulsion system as recited in claim 1, including at least one heat exchanger configured to communicate thermal energy from the high energy gas flow into the working fluid flow.

12. The propulsion system as recited in claim 1, wherein the first power turbine is coupled to a shaft of the core engine through the first output shaft.

13. The propulsion system as recited in claim 12, including a coupling device configured to transfer power from the first output shaft into the shaft of the core engine.

14. A bottoming cycle system for recovering energy from a heat source, the bottoming cycle system comprising:
a plurality of cycle turbines configured to drive a corresponding plurality of cycle compressors at a cycle speed in response to expansion of a heated working fluid flow between a first inlet and a first outlet of each of the plurality of cycle turbines; and
a first power turbine configured to drive a first output shaft at a power speed that is different than the cycle speed in response to expansion of a working fluid flow received from one of the plurality of cycle turbines.

15. The bottoming cycle system as recited in claim 14, including a first power conversion device coupled to the output shaft and configured to generate power in response to rotation of the first output shaft.

16. The bottoming cycle system as recited in claim 15, wherein the power conversion device comprises one of an electric machine, pump, gearbox or mechanical machine.

17. The bottoming cycle system as recited in claim 14, wherein the plurality of cycle turbines comprises three cycle turbines arranged in flow series communication such that working fluid flow exhausted from a first cycle turbine is communicated to a second cycle turbine and then communicated to a third cycle turbine.

18. The bottoming cycle system as recited in claim 17, including a second power turbine in flow series communication with the first power turbine and flow exhausted from third cycle turbine is communicated to the first power turbine and flow exhausted from the first power turbine is communicated to the second power turbine.

19. The bottoming cycle system as recited in claim 15, including a second power turbine configured to drive a second output shaft at the power speed and a second power generation device configured to generate power in response to rotation of the second output shaft.

20. The bottoming cycle system as recited in claim 19, wherein the plurality of cycle turbines comprises three cycle turbines arranged in flow series with the first power turbine and the second power turbine such that working fluid flow exhausted from a first cycle turbine is communicated to the first power turbine, flow exhausted from the first power turbine is communicated to the second cycle turbine, flow exhausted from the second cycle turbine is communicated to the second power turbine and flow exhausted from the second power turbine is communicated to the third cycle turbine.

21. The bottoming cycle system as recited in claim 14, wherein the plurality of cycle compressors are arranged in a serial flow configuration such that flow from one of the plurality of cycle compressors is communicated to a next one of the plurality of compressors.

22. The bottoming cycle system as recited in claim 21, wherein the plurality of cycle compressors are in communication with at least one recuperator for transferring thermal energy from a higher temperature, lower pressure point of the working fluid flow into a lower temperature, higher pressure point of the working flow.

23. The bottoming cycle system as recited in claim 14, wherein the first output shaft is coupled to a shaft of a turbine engine.

24. The bottoming cycle system as recited in claim 23, including a coupling device configured to transmit power from the first output shaft into the shaft of the turbine engine.
